(19) United States
(12) Patent Application Publication
(10) Pub. No.: US 2013/0242368 A1
(43) Pub. Date: Sep. 19, 2013

(54) FAST RESPONSE PHOTOCHROMIC COMPOSITION AND DEVICE

(71) Applicants: Yuval Ofir, Modiin (IL); Ariela Donval, Rosh Haayin (IL); Moshe Oron, Rehovot (IL); Doron Vevo, Ra'anana (IL)

(72) Inventors: Yuval Ofir, Modiin (IL); Ariela Donval, Rosh Haayin (IL); Moshe Oron, Rehovot (IL); Doron Vevo, Ra'anana (IL)

(73) Assignee: KiloLambda Technologies Ltd., Tel Aviv (IL)

(21) Appl. No.: 13/885,053

(22) PCT Filed: Dec. 7, 2011
(86) PCT No.: PCT/IB2011/055534

§ 371 Date: May 13, 2013

Related U.S. Application Data
(60) Provisional application No. 61/421,291, filed on Dec. 9, 2010.

(51) Int. Cl. G02B 1/04; G02B 5/23

(52) U.S. Cl. CPC G02B 1/04; G02B 5/23
USPC 359/241; 252/586

(57) ABSTRACT

The present invention relates to optical power-limiting device, and more particularly, to an optical power-limiting passive device and to a method for limiting optical power transmission in lenses and windows, using absorption changes in a photochromic material with a fast response, featuring under a millisecond rise time and one to five seconds return/decay time.

### FIELD OF THE INVENTION

The present invention relates to optical power-limiting device, and more particularly, to an optical power-limiting passive device and to a method for limiting optical power transmission in lenses and windows, using absorption changes in a photochromic material with a fast response, featuring under a millisecond rise time and one to five seconds return/decay time. Such ultra-fast response times were not realized in the past.

The present invention further concerns, but is not limited to, the production of windows, lenses, contact lenses, microlenses, mirrors and other optical articles. Special optical elements against sun blinding, flash blinding, flash dazzling, flashing lights originating from explosions in the battle fields, welding light, fire related blinding, and lenses for cameras that look directly at the sun or missile launching, and other bright emitting sources.

The present invention further concerns uses of the limiter for power regulation in networks, in the input or at the output from components. Further uses are in the areas of medical, military and industrial lasers where an optical power limiter may be used for surge protection and safety applications.

### BACKGROUND OF THE INVENTION

Photochromic materials are known and exhibit a change in light transmission or color in response to actinic radiation in the spectrum of sunlight. Removal of the incident radiation causes these materials to revert back to their original transmissive state.

Such photochromic materials have applications like sunglasses, graphics, ophthalmic lenses, solar control window films, security and authenticity labels, and many others. The use of photochromic materials, however, has been very limited due to (a) degradation of the photochromic property of the materials from continued exposure, absorption and heating of ultra-violet (UV) light, particularly short wavelength (<400 nanometers (nm)), and to infrared (IR) radiation (>780 nm), and (b) the long rise and decay times of the darkening (up to minutes).

Ophthalmic lenses made of mineral glass are well known. Photochromic pigments have good compatibility with mineral glass. However, photochromic mineral glass lenses are heavy and have a slow photochromic reaction time, particularly in the change from dark to light.

Today, most spectacle lenses are made from of a variety of plastics or from plastic-glass composites. Commonly used plastics include PMMA (e.g. Plexiglas by Rohm and Haas, Perspex, Lucite, Altuglas and Optiks by Plaskolite,) and Polycarbonate (e.g. Lexan by General Electric, MERLON by Mobay Chemical Company, MAKROLON by Bayer, and PANLITE from Teijin Chemical Limited). Recently, attempts have been made to apply photochromic pigments to light-weight plastic lenses to render them similarly photochromic. However, for various reasons this objective has not been satisfactorily achieved with the existing plastic lenses.

Some success to rendering plastic ophthalmic lenses photochromic have involved embedding a solid layer of photochromic mineral glass within the bulk of the organic lens material. Examples include U.S. Pat. No. 5,232,637 (Dasher et al.) that teaches a method of producing a glass-plastic laminated ophthalmic lens structure, and U.S. Pat. No. 4,300,821 (Mignen et al.) that teaches an ophthalmic lens made of organic material having at least one layer of photochromic mineral glass within its mass to impart photochromic properties to the lens.

Recently U.S. Pat. No. 5,462,698 (Kobayakawa et al.) entitled “Photochromic Composition” addressed the problems associated with specific photochromic compounds which tend to be slow-acting or inactive when incorporated in plastic, and solved the problem by use of a resin compound having at least one epoxy group in the molecule as the resin for forming the photochromic lens. However, this solution to the problem has limitations and drawbacks, such as the solution (a) is directed to forming a lens having photochromic compound dispersed throughout, (b) requires the presence of multiple types of photochromic compounds in combination, (c) requires the use of a polymerizable compound having at least one epoxy group to form the lens, (d) requires polymerization in a heat furnace, where polymerization taking from 2 to 40 hours, and (e) reported return/decay time to ½ optical density, measured after exposure to 60 seconds of light, is about 3 minutes. Kobayakawa et al. thus uses specific materials and requires a long time to produce a slow acting lens.

More recently U.S. Pat. No. 5,531,940 (Gupta et al.) teaches methods for making optical plastics lenses with photochromic additives. According to a first embodiment of the invention, a casting resin having a low cross link density comprising polymerizable components (preferably including up to 50 weight % bisallyl carbonate) and photochromic additives. There, all the polymerizable components have functionality not greater than two. They are placed between a mold and a lens-preform and cured. However, upon polymerization the resin has a low crosslink density and forms a soft matrix. This soft matrix is unsuitable as the outer layer for photochromic lenses. According to a second embodiment of the invention, the casting resin, free of photochromic additives, is arranged between a mold and a lens preform and then cured. The resin is then impregnated with photochromic additives. In a third embodiment, the layering resin containing a photochromic additive is placed on the surface of a mold and cured to a gel state. Then, a casting resin, that is substantially free of photochromic additives, is arranged between the coated mold and a lens preform and cured. According to a fourth embodiment, a casting resin that is substantially free of photochromic additives is provided on the surface of a mold and cured to a gel state. Then, a casting resin containing photochromic additives is arranged between the coated mold and a lens preform and cured. There is no discussion of photochromic rate of reversal, and the photochromic material is represented as being too soft to expose to the environment.

Since all known materials have a long on and return/decay times, tens of seconds to minutes, there are many applications that call for a shorter rise and fall time of the opacity, there is a need for a photochromic plastic device with a fast rise and decay time, including lenses, windows, and filters.

### SUMMARY OF THE INVENTION

It is the object of some embodiments of the present invention to provide a three-component composition of a matrix, a photochromic dye, and a thermal conductivity enhancing additive, that produces a fast response, featuring a rise time of less than about a millisecond and a return/decay time of from about 1 to about 5 seconds.

It is further the object of some embodiments of the present invention to provide a four component composition consisting of a matrix, a photochromic material, a thermal conductivity enhancing additive, and an environmental stabilizer, that produces a fast response, featuring under a rise time of less than about a millisecond and a return/decay time of from about 1 to about 5 seconds.

The matrix is a transparent adhesive or polymer film or polymerizable composition that can incorporate the photochromic material, the thermal conductivity enhancers, and environmental stabilizers.

Photochromic materials are materials that turn from transparent to tinted in the visible range when exposed to UV radiation or to certain part of the visible range. A wide variety of photochromic materials may be incorporated in the photochromic matrix of the present invention. Suitable photochromic materials include inorganic photochromic material, organic photochromic material and mixtures thereof. The photochromic material may be a single photochromic compound; a mixture of photochromic compounds; a material comprising a photochromic compound, such as a monomeric or polymeric ungelled solution; a material such as a monomer or polymer to which a photochromic compound is chemically bonded; a material comprising and/or having chemically bonded to it a photochromic compound, the outer surface of the material being encapsulated (encapsulation is a form of coating), e.g., with a polymeric resin or a protective coating such as a metal oxide that prevents contact of the photochromic material with external materials such as oxygen, moisture and/or chemicals. Suitable organic materials are pyrans, oxazines, fulgides, fulgimides, diarylethenes and mixtures thereof. The photochromic material or materials can be introduced in quantities ranging from 0.1%-20% by weight, and more specifically from 1%-10% by weight.

The thermal conductivity enhancing additives are materials that increase the thermal conductivity of the matrix, serving three purposes. (a) First, heat that builds up in the optical element during the absorption of light is easily transferred to other elements in the system or outer surfaces that are air cooled. The thermal conductivity enhancing additives thus effectively reduce the thermal degradation of both the matrix and the photochromic dye by reducing the effects of heat during light absorption. (b) Second, since most photochromic dyes return and/or decay from their colored form (tinted form) to their transparent form by the absorption of visible light and by heat, removing the heat changes the equilibrium of colored and colorless molecules, thus enhancing the return and/or decay from the tinted form to the transparent form and reverse. (c) Third, the photochromic materials, when exposed to high fluxes of light, are bleached, and return to transparency at times when they should be tinted. This phenomenon does not occur when the matrix is efficiently conducting heat from the exposed area. Thermal conductivity of polymeric, transparent matrixes is achieved by the addition of heat-conducting nanoparticles, that are much smaller than the visible light wavelength and do not affect the transparency. Examples of such nanoparticles include nanorodes, nanowires, hollow nanoparticles, core-shell nanoparticles, spiked particles, and nanoparticles with various other shapes. The nanoparticles can be composed of metals such as Gold, Silver, Aluminum, Tungsten, Chromium, Copper, Lead, Molybdenum, Nickel, Platinum, Zinc, and Tin and others as well as oxides, nitrides, carbides and sulfides of the metal, which can be conductive (“metallic”) and/or semiconductive, e.g., Silicon carbide (SiC), Silicon nitride, Indium Tin Oxide (ITO), WO₂, V₂O₅, Aluminum nitride (AlN), Aluminum oxide (Al₂O₃), cemented carbide (tungsten-carbide cobalt), and others. In addition, carbon forms such as nanodiamond, diamond-like carbon (DLC), single-wall carbon nanotubes, double-wall carbon nanotubes, multiwall carbon nanotubes, and their functionalized forms, graphene. Other suitable materials are sapphire, quartz, and boron nitride. The above materials may be used as elements, mixtures, alloys, or bimetallic particles that serve as good thermal conductivity enhancing additives.

The environmental stabilizers are materials that stabilize the device against damage due to UV radiation. Suitable stabilizers include UV absorbers and stabilizers, triplete quenchers, singlet oxygen quenchers and antioxidants, these are added to extend the shelf-life of the photochromic device.

In yet another objective of some embodiments of the present invention, the various compositions proposed can be polymerized or cured in the form of nanoparticles and/or microparticles. The nanoparticles and/or the microparticles can be further dispersed in a new matrix, appropriate for forming a window, a lens, glasses, a contact lens, a filter, a microlens array, and mirrors.

In yet another objective of some embodiments of the present invention, the various nanoparticles and/or microparticles of the present composition can be further coated with a coating. The coating can have a number of functions including: protection of the core composition from oxidation or any form of degradation, blocking out harmful radiation, and change the chemical nature of the particles (hydrophobic/hydrophilic) and hence their dispersability. The coating can be organic, inorganic or a composite, and in the form of a monolayer, a multilayer, or a porous layer.

Experiments carried out at inventors laboratory showed fast photochromic response time less than 30 milliseconds and decay time less than 5 sec.

The present invention further concerns, but is not limited to, the production of windows, lenses, contact lenses, microlenses, mirrors, filters and other optical articles, and the production of special optical elements against sun blinding, flash blinding, flash dazzling, flashing lights originating from explosions in the battle fields, welding light, fire related blinding, and lenses for cameras to look directly at the sun or missile launching, and other bright emitting sources. Some embodiments of the invention also make it possible to produce photochromic non-prescription lenses (piano lenses, e.g., sunglasses, safety glasses, reading glasses, etc.), as well as prescription, multifocal, progressive or non-prescription plastic or plastic-glass laminate optical quality eyeglass, where the fast change from transparent to tinted and back is fast.

### BRIEF DESCRIPTION OF THE DRAWINGS

The invention will now be described in connection with certain preferred embodiments with reference to the following illustrative figures so that it may be more fully understood. With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

FIG. 1 shows a cross-sectional view of a photochromic three components bulk device.

FIG. 2 shows a cross-sectional view of a photochromic four components bulk device.

FIG. 3 shows a cross-sectional view of a three components laminate.

FIG. 4 shows across-sectional view of a four components laminate.

FIG. 5 shows a cross-sectional view of a three components coating.

FIG. 6 shows across-sectional view of a four components coating.

FIG. 7 shows a cross-sectional view of photochromic nano-spheres in the bulk device.

FIG. 8 shows a cross-sectional view of three parts composition nano and or micro-particles.

FIG. 9 shows a cross-sectional view of four components composition nano and or micro-particles.

FIG. 10 shows a cross-sectional view of coated three components composition nano and or micro-particles.

FIG. 11 shows a cross-sectional view of coated four components composition nano-particles and/or micro-particles.

### DETAILED DESCRIPTION

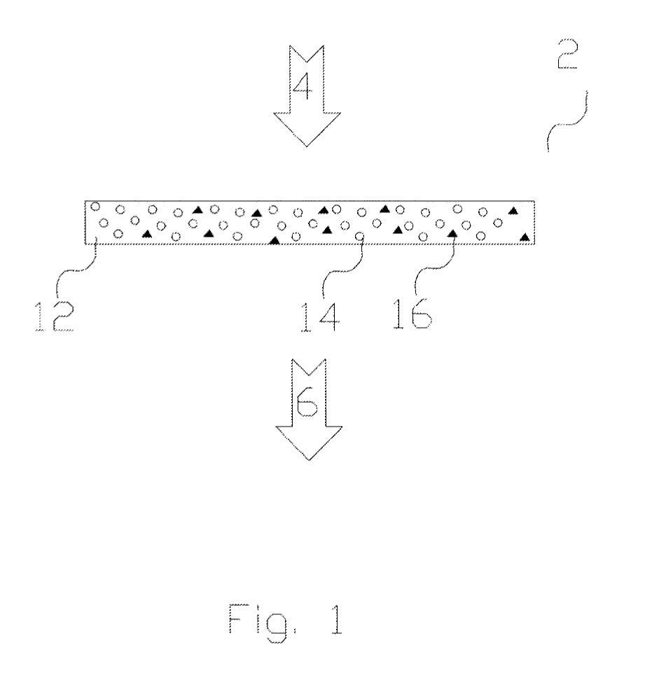

FIG. 1 depicts a cross-sectional view of a photochromic bulk device 2 comprising a matrix 12, a photochromic material 14, and thermal conductivity enhancing nanomaterial additives 16. The optical element absorbs part of the light beam 4 which impinges on it, changes its color and transparency, and effectively transmits only part of the light 6. When the light 4 is switched off, the transparency is resumed, and light beam 6 is about as intense as 4.

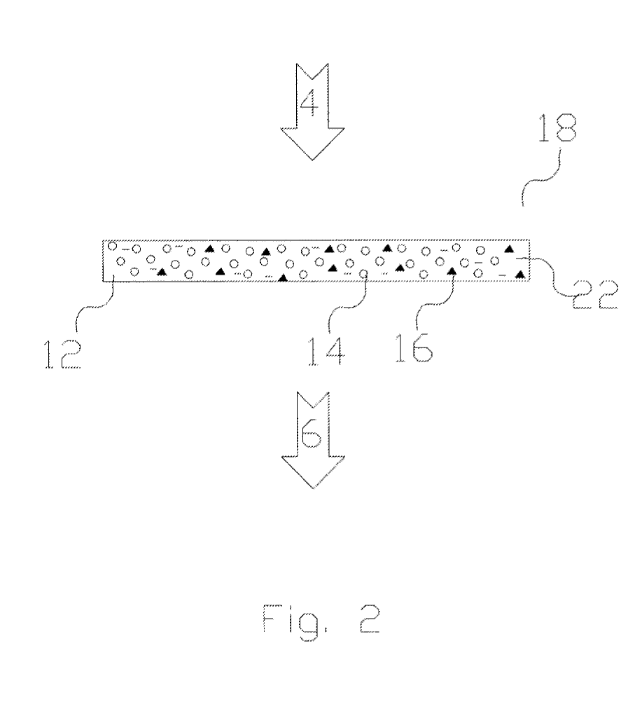

FIG. 2 depicts a cross-sectional view of a photochromic bulk device 18 comprising a matrix 12, a photochromic material 14, thermal conductivity enhancing nanomaterial additives 16, and an environmental stabilizer 22. The optical element absorbs part of the light beam 4 which impinges on it, changes its color and transparency, and effectively transmits only part of the light 6. When the light 4 is switched off, the transparency is resumed, and light beam 6 is about as intense as 4.

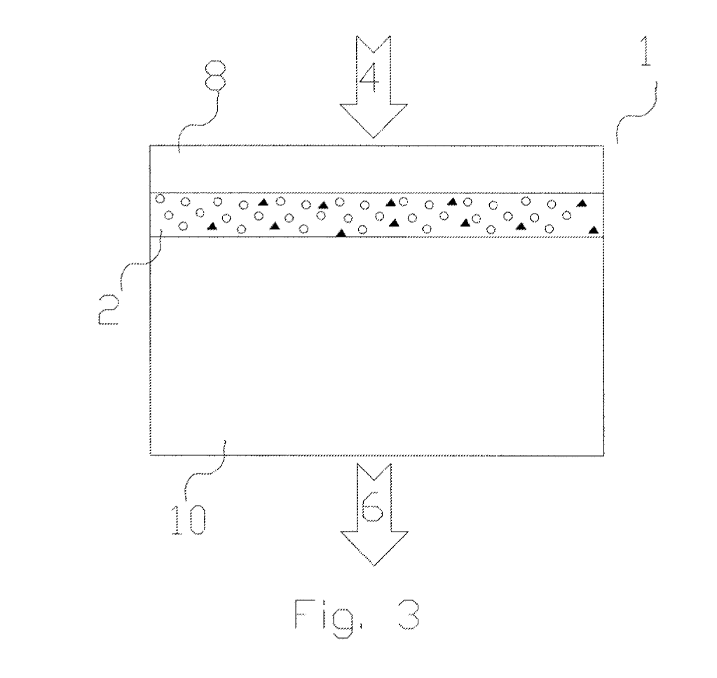

FIG. 3 depicts a cross-sectional view of a laminate 1 incorporating a substrate 8, a photochromic composition 2, and a further substrate 10. The optical element 1 absorbs part of the light beam 4 which impinges on it, changes its color and transparency, and effectively transmits only part of the light 6. When the light 4 is switched off, the transparency is resumed, and light beam 6 is about as intense as 4.

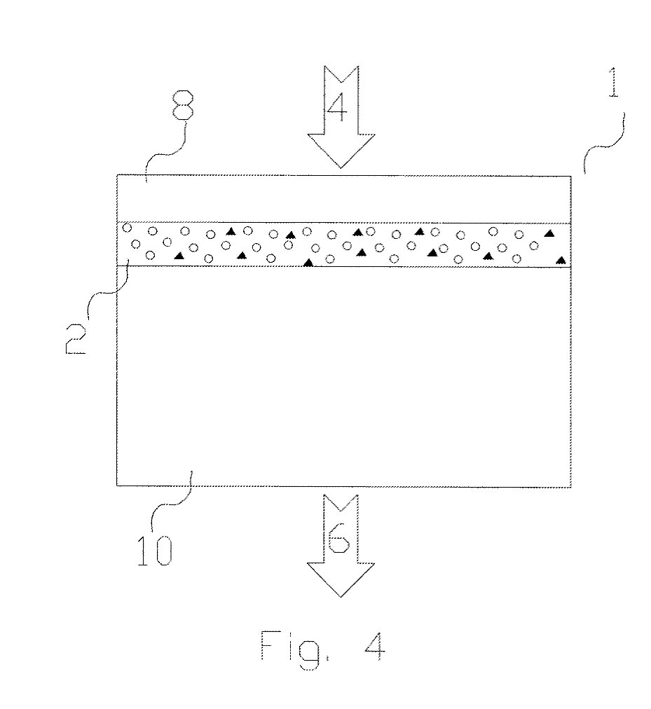

FIG. 4 depicts a cross-sectional view of a laminate 19 incorporating a substrate 8, a photochromic composition 18, and a further substrate 10. The optical element 19 absorbs part of the light beam 4 which impinges on it, changes its color and transparency, and effectively transmits only part of the light 6. When the light 4 is switched off, the transparency is resumed, and light beam 6 is about as intense as 4.

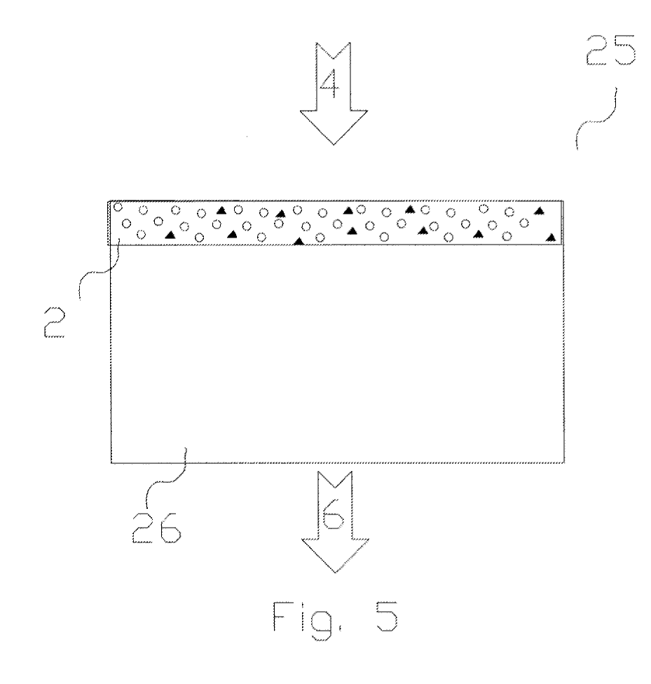

FIG. 5 depicts a cross-sectional view of a coating 25 incorporating a substrate 26, and a photochromic composition layer 2. The optical element 25 absorbs part of the light beam 4 which impinges on it, changes its color and transparency, and effectively transmits only part of the light 6. When the light 4 is switched off, the transparency is resumed, and light beam 6 is about as intense as 4.

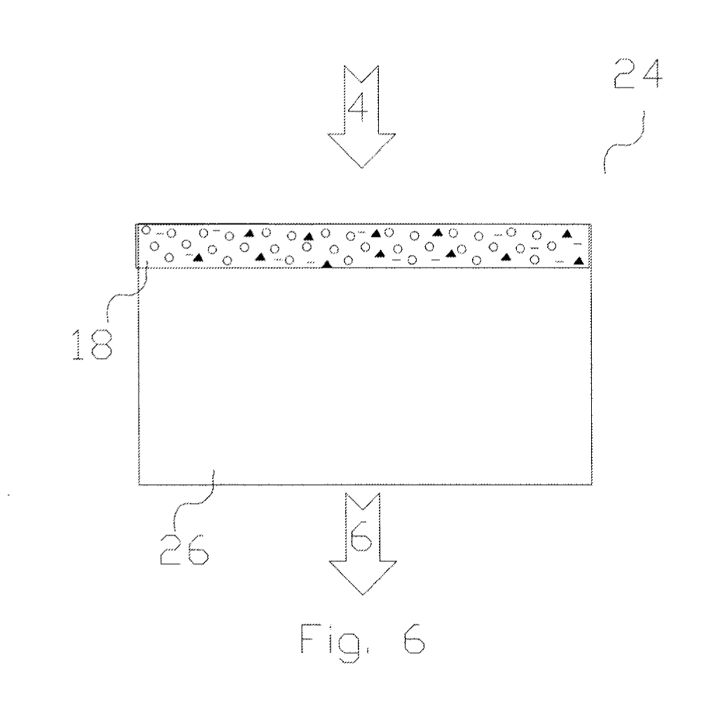

FIG. 6 depicts a cross-sectional view of a coating 24 incorporating a substrate 26, and a photochromic composition layer 18. The optical element 24 absorbs part of the light beam 4 which impinges on it, changes its color and transparency, and effectively transmits only part of the light 6. When the light 4 is switched off, the transparency is resumed, and light beam 6 is about as intense as 4.

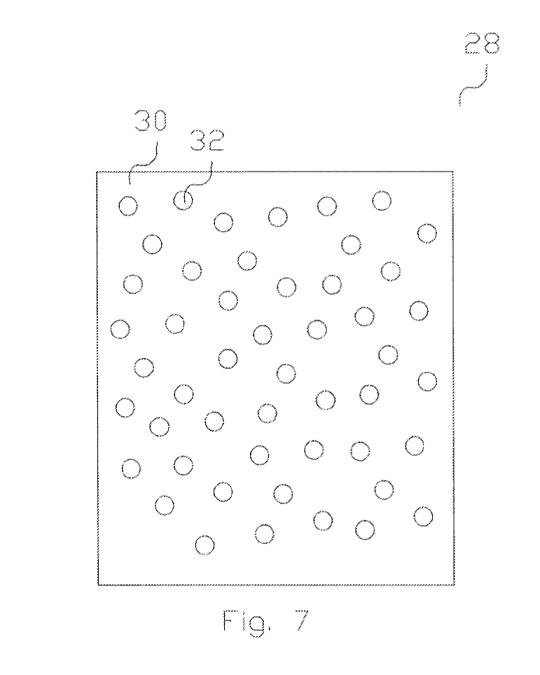

FIG. 7 depicts a cross-sectional view of a photochromic bulk element 28 comprising a matrix 30, and a photochromic composition in the form of nanoparticles and/or microparticles 32 dispersed within.

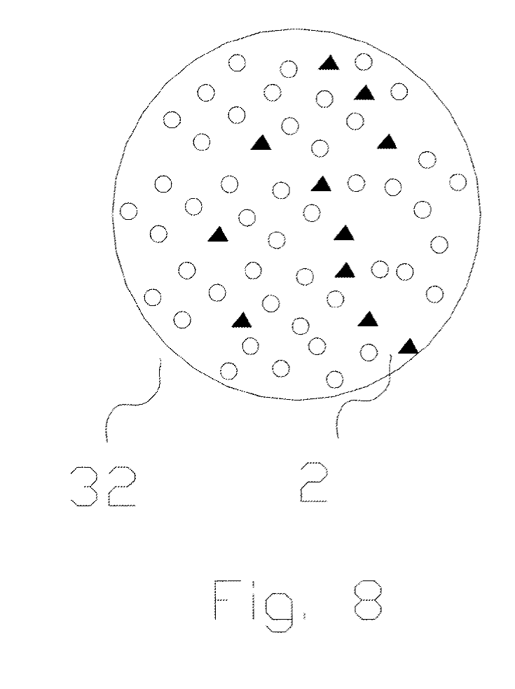

FIG. 8 depicts a cross-sectional view of nano-particle and/or micro-particle 32 based on composition 2.

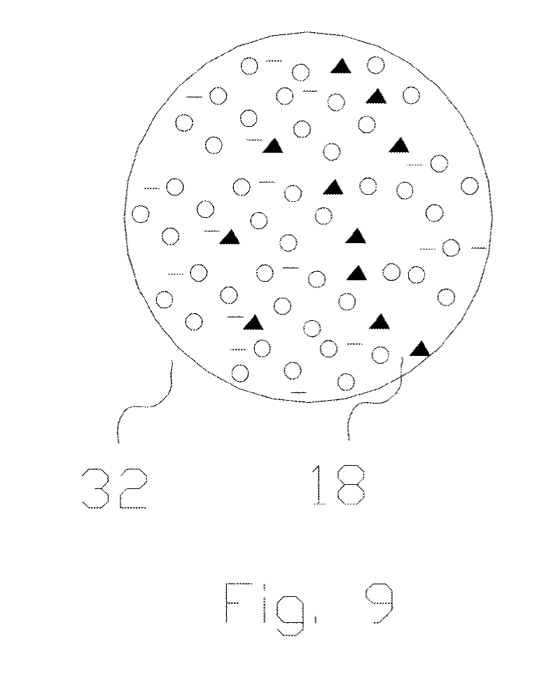

FIG. 9 is a cross-sectional view of nano-particle and/or micro-particle 32 based on composition 18.

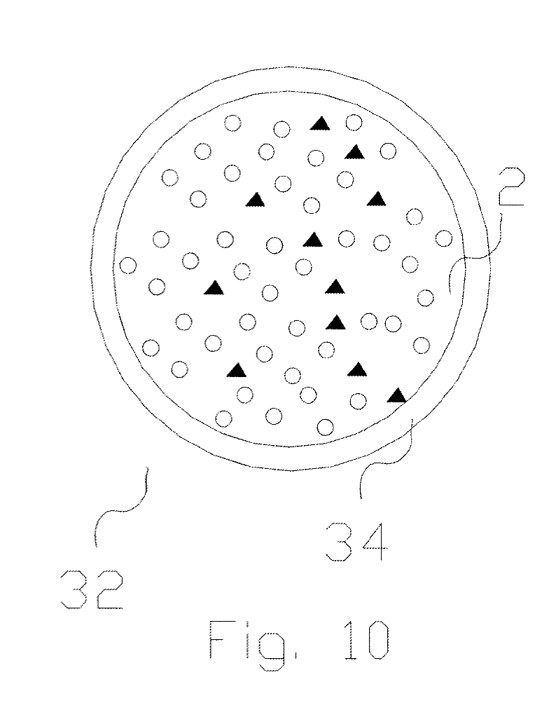

FIG. 10 depicts a cross-sectional view of nanoparticles and/or microparticles 32 based on composition 2, which is further coated with a layer 34.

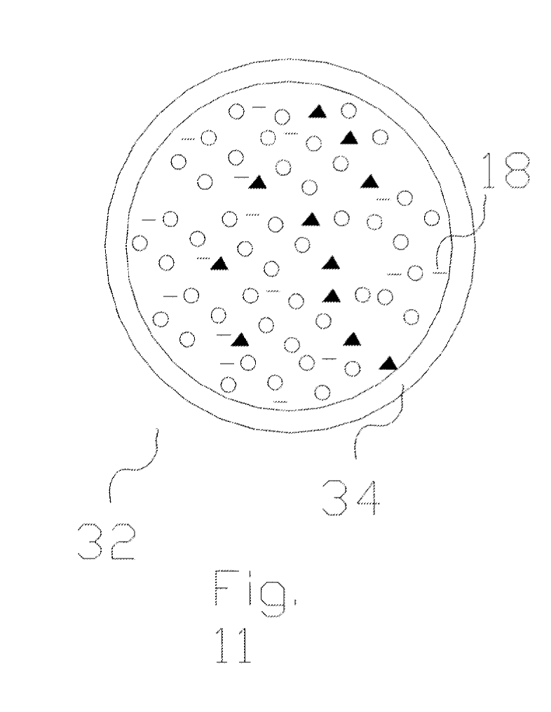

FIG. 11 depicts a cross-sectional view of nano-particle and/or micro-particle 32 based on composition 18, which is further coated with a layer 34.

### EXAMPLES

Example: This Example demonstrates a composition of materials for creating a fast responding photochromic laminate, prepared and tested at the applicants laboratory.

The preparation of the three component photochromic laminate is as follows: A 25 mL vial is filled with 2 gr of a polyurethane adhesive as a matrix, 0.04 gr of a photochromic dye (Vivimed Labs Europe) as the photochromic material and 0.02 gr of carbon nanotubes coated with silver nanoparticles (Bioneer Corporation) as the thermal conductivity enhancing additive. The mixture is sonicated using an ultrasonic finger (Vibra Cell VCX-130), to disperse the nanotubes, and is further magnetically stirred until all the photochromic dye dissolves. A laminate is formed by applying an approximately 100 micron thick layer between two glass slides. The laminate is then exposed to UV light to cure the adhesive. Alternatively, the laminate cured by placing the laminate in an oven at 80° C. for 60 hours.

Testing of the photochromic response is carried out by subjecting the cured laminate to a commercial light flash source (Bowens esprit 500) having a pulse length of 1 millisecond. The laminate immediately darkens, and returns to its uncolored state within 2 seconds.

1. A mixture used for fast photochromic devices comprising:
a photochromic dye;
a matrix material; and
a thermal conductivity enhancer.

2. The mixture according to claim 1, wherein said mixture comprises anywhere from about 0.1% to about 20% photochromic dye.

3. The mixture according to claim 2, wherein said mixture comprises anywhere from about 1% to about 10% photochromic dye.

4. The mixture according to claim 1, wherein said matrix is an optically cured adhesive.

5. The mixture according to claim 1, wherein said matrix is a thermally cured adhesive.

6. The mixture according to claim 1, wherein said matrix is chosen from hotmelt adhesives, plastisol adhesives, heat-sealing adhesives, high-frequency sensitive heat-sealing adhesives, contact cements, pressure sensitive adhesives, aqueous emulsion adhesives, multi-purpose adhesives, solvent adhesives or mixtures thereof.

7. The mixture according to claim 1, wherein said matrix is a thermoplastic material and is chosen from nylon, poly(vinyl acetate), vinyl chloride-vinyl acetate copolymer, poly(C,-C8 alkyl) acrylates, poly(C,-C8 alkyl) methacrylates, styrene-butadiene copolymer resin, poly(urea-urethane), polyurethane, polyterephthalate, polyvinylbutyral, polycarbonate, polycarbonate-silicone copolymer or mixtures thereof.

8. The mixture according to claim 1, wherein said photochromic dye is chosen from an inorganic photochromic material, an organic photochromic material or mixtures thereof.

9. The mixture according to claim 1, wherein said photochromic dye is an organic photochromic material and is chosen from pyrans, oxazines, fulgides, fulgimides, diarylethenes or mixtures thereof.

10. The mixture according to claim 1, wherein said thermal conductivity enhancer is a material that includes at least one of nanorodes, nanowires, hollow nanoparticles, core-shell nanoparticles, spiked particles, or nanoparticles with various shapes.

11. The mixture according to claim 10, wherein said thermal conductivity enhancer material is a metal and includes at least one of Gold, Silver, Aluminum, Tungsten, Chromium, Copper, Lead, Molybdenum, Nickel, Platinum, Zinc, or Tin.

12. The mixture according to claim 10, wherein said thermal conductivity enhancer material includes at least one of an oxide, a nitride, a carbide or a sulfide that are at least one of a metal or a semiconductor material.

13. The mixture according to claim 10, wherein said thermal conductivity enhancer material is a form of carbon and includes at least one of nanodiamond, graphene, diamond like carbon (DLC), single-wall carbon nanotubes, double-wall carbon nanotubes, multiwall carbon nanotubes, carbon black, or their chemically functionalized forms.

14. The mixture according to claim 10, wherein said thermal conductivity enhancer material is sapphire, quartz, or boron nitride.

15. The mixture according to claim 1, further comprising spacers.

16. The mixture according to claim 1, further comprising stabilizers.

17. The mixture according to claim 1, wherein a transition half time from an un-actuated state to an actuated state is less than 2 milliseconds, and the transition half time from an actuated state to an un-actuated state is less than 5 seconds.

18. An optical element comprising:
a carrier substrate; and
a mixture disposed on said carrier substrate, said mixture comprising a photochromic dye and a matrix material.

19. The optical element of claim 18 wherein said carrier substrate is chosen from mineral glass, ceramic material, or polymeric organic material and wherein said carrier substrate is an ophthalmic article.

20. The optical element of claim 19 wherein said ophthalmic article is a lens.

21. The optical element of claim 19 wherein said polymeric organic material is a material chosen from thermosetting materials, thermoplastic materials or mixtures thereof.

22. The optical element of claim 19 wherein said polymeric organic material is a thermoplastic material and is chosen from nylon, poly(vinyl acetate), vinyl chloride-vinyl acetate copolymer, poly(C,-C8 alkyl) acrylates, poly(C,-C8 alkyl) methacrylates, styrene-butadiene copolymer resin, poly(urea-urethane), polyurethane, polyterephthalate, polycarbonate, polycarbonate-silicone copolymer or mixtures thereof.

23. The mixture according to claim 1, wherein said mixture is in the form of nanoparticles or microparticles.

24. The mixture according to claim 23, wherein the nanoparticles or microparticles are prepared using an emulsion polymerization process, a double emulsion process, a microfluidic reactor, a mixer, a micromixer, an homogenizer, a sonication process, a lithographic process, or a spray drying technique.

25. The mixture according to claim 23, wherein the nanoparticles or microparticles are further coated with an additional coating.

26. The mixture according to claim 25, wherein the additional coating is an inorganic material, an organic material, or a composition thereof.

27. The mixture according to claim 26, wherein the organic material is an organic ligand, a polymer, a copolymer, a block-copolymer, or a composition thereof.

28. The mixture according to claim 26, wherein the inorganic material is a metal, an oxide, a nitride, a sol-gel, a carbide, or a composition thereof.

29. An optical element comprising:
a carrier substrate; and
a mixture disposed on said carrier substrate, said mixture in the form of nanoparticles or microparticles comprising a photochromic dye, a thermal conductivity enhancer, and a matrix.

30. The optical element of claim 29, wherein said matrix is a thermosetting material, a thermoplastic material, or a mixture thereof.

31. The optical element of claim 29, wherein said matrix is a thermoplastic material and is chosen from nylon, poly(vinyl acetate), vinyl chloride-vinyl acetate copolymer, poly(C,-C8 alkyl) acrylates, poly(C,-C8 alkyl) methacrylates, styrene-butadiene copolymer resin, poly(urea-urethane), polyurethane, polyterephthalate, polycarbonate, polycarbonate-silicone copolymer or mixtures thereof.

32. The optical element of claim 29, wherein said carrier substrate is chosen from mineral glass, ceramic material, or polymeric organic material and wherein said carrier substrate is an ophthalmic article.

33. The optical element of claim 32, wherein said ophthalmic article is a lens.

34. The optical element of claim 32, wherein said polymeric organic material is a material chosen from thermosetting materials, thermoplastic materials or mixtures thereof.

35. The optical element of claim 19, wherein said polymeric organic material is a thermoplastic material and is chosen from nylon, poly(vinyl acetate), vinyl chloride-vinyl acetate copolymer, poly(C,-C8 alkyl) acrylates, poly(C,-C8 alkyl) methacrylates, styrene-butadiene copolymer resin, poly(urea-urethane), polyurethane, polyterephthalate, polycarbonate, polycarbonate-silicone copolymer or mixtures thereof.

36. The mixture according to claim 12, wherein the metallic or the semiconductive material includes: Silicon Carbide (SiC), Silicon nitride, Indium Tin Oxide (ITO), WO2, V2O5, Aluminum nitride (AlN), Aluminum oxide (Al2O3), or Cemented carbide (tungsten-carbide cobalt).

37. The optical element of claim 29, wherein the optical element has a photochromic response time less than 30 milliseconds and a decay time less than 5 seconds.

38. The mixture according to claim 1, wherein said thermal conductivity enhancer is a nanoparticle that increases the thermal conductivity of the matrix so as to convey heat away from the photochromatic dye and thereby reduce the effects of heat on the photochromatic dye during light absorption.

39. The mixture according to claim 1, wherein the mixture has a photochromic response time less than about 30 milliseconds and a decay time less than 5 seconds.

40. The optical element according to claim 18, wherein the mixture disposed on said carrier substrate further comprises a thermal conductivity enhancer.

41. The optical element according to claim 42, wherein said thermal conductivity enhancer is a nanoparticle that increases the thermal conductivity of the matrix so as to convey heat away from the photochromatic dye and thereby reduce the effects of heat on the photochromatic dye during light absorption.

42. The optical element according to claim 42, wherein said thermal conductivity enhancer is nanodiamond, graphene, diamond like carbon (DLC), single-wall carbon nanotubes, double-wall carbon nanotubes, multiwall carbon nanotubes, carbon black, or their chemically functionalized forms.

43. The optical element according to claim 42, wherein the optical element has a photochromic response time less than about 30 milliseconds and a decay time less than 5 seconds.

44. A mixture used for fast photochromic devices comprising:
at least one photochromic dye selected from the group consisting of pyrans, oxazines, fulgides, fulgimides, diarylethenes and inorganic photochromic dyes;
at least one matrix material selected from the group consisting of hotmelt adhesives, plastisol adhesives, heat-sealing adhesives, high-frequency sensitive heat-sealing adhesives, contact cements, pressure sensitive adhesives, aqueous emulsion adhesives, multi-purpose adhesives and solvent adhesives; and
at least one thermal conductivity enhancer selected from the group consisting of nanorodes, nanowires, hollow nanoparticles, core-shell nanoparticles, spiked particles, and nanoparticles.

45. An optical element comprising:
at least one carrier substrate selected from the group consisting of mineral glass, ceramic material and polymeric organic material, and
a mixture disposed on said carrier substrate, said mixture in the form of nanoparticles or microparticles comprising
at least one photochromic dye selected from the group consisting of pyrans, oxazines, fulgides, fulgimides, diarylethenes and inorganic photochromic dyes,
at least one thermal conductivity enhancer selected from the group consisting of nanorodes, nanowires, hollow nanoparticles, core-shell nanoparticles, spiked particles, and nanoparticles, and
at least one matrix material selected from the group consisting of hotmelt adhesives, plastisol adhesives, heat-sealing adhesives, high-frequency sensitive heat-sealing adhesives, contact cements, pressure sensitive adhesives, aqueous emulsion adhesives, multi-purpose adhesives and solvent adhesives.
